(19) United States
(12) Patent Application Publication
(10) Pub. No.: US 2024/0362641 A1
(43) Pub. Date: Oct. 31, 2024

(54) SYSTEMS AND METHODS FOR MITIGATING DONATION FRAUD

(71) Applicant: Wells Fargo Bank, N.A., San Francisco, CA (US)

(72) Inventors: Andrea Renee Leighton, San Francisco, CA (US); Alexander Youngblood Windsor, San Francisco, CA (US)

(73) Assignee: Wells Fargo Bank, N.A., San Francisco, CA (US)

(21) Appl. No.: 18/643,854

(22) Filed: Apr. 23, 2024

Related U.S. Application Data
(60) Provisional application No. 63/461,884, filed on Apr. 25, 2023.

(51) Int. Cl. G06Q 20/40

(52) U.S. Cl. CPC G06Q 20/4016

(57) ABSTRACT

A computing system includes a network interface configured to communicate with a user device and a third party system, a database configured to store information regarding the third party system, and a processing circuit that causes a processor to: receive, via the network interface, third party information including an identifier of a third party account from the third party system; store the third party information in the database; generate and provide a GUI comprising a selectable graphical representation of a third party associated with the third party system that does not include the identifier associated with the third party account to the user device; receive, via the network interface, a user input to the GUI indicating a selection to transfer resources to the third party; and cause a transfer of resources from an account associated with the user device to the third party account associated with the third party system.

### CROSS-REFERENCE TO RELATED APPLICATION

This application claims the benefit of and priority to U.S. Provisional Patent Application No. 63/461,884, filed Apr. 25, 2023, which is incorporated herein by reference in its entirety.

### TECHNICAL FIELD

The present disclosure relates to systems and methods for mitigating donation fraud.

### BACKGROUND

Customers may use various payment methods, including mobile banking applications, to make payments or transfer funds to one or more recipients. Typically, a customer must indicate a personalized token or other identifier of a recipient to effectuate the payment. However, fraudsters continue to become increasingly sophisticated in their techniques for perpetrating fraud. For example, in some instances, fraudsters may attempt to manipulate the personalized token of a recipient to commit fraud. Therefore, computerized systems and methods to mitigate against fraud by concealing recipient tokens is desired.

### SUMMARY

At least one arrangement relates to a computing system of a provider institution, comprising: a network interface configured to communicate with a user device and a plurality of third party systems; a database configured to store information regarding a plurality of accounts of the provider institution; and a processing circuit comprising at least one processor and at least one memory, the at least one memory structured to store instructions that are executable to cause the at least one processor to: receive, via the network interface, first third party information from a first third party system of the plurality of third party systems, the first third party information including a first third party account and a selection of a first category type of the first third party system; receive, via the network interface, second third party information from a second third party system of the plurality of third party systems, the second third party information including a selection of a second category type of the second third party system; generate a graphical user interface (GUI), the GUI comprising a first graphical representation of the first category type and a second graphical representation of the second category type; provide, via the network interface, the GUI to the user device; receive, via the network interface, a first user input to the GUI indicating a selection to transfer a resource from an account of the plurality of accounts to the first third party account of the first third party system; update, responsive to receiving the selection to transfer the resource, a total amount associated with the first category type; compare the total amount associated with the first category type with historical transaction data of the account stored in the database; determine, based on the comparison, that the total amount associated with the first category type exceeds a total amount associated with the second category type; and automatically update, via the network interface, a position of the first graphical representation of the first category type relative to the second graphical representation of the second category type on the GUI responsive to determining that the total amount associated with the first category type exceeds the total amount associated with the second category type.

At least one arrangement relates to a computing system of a provider institution, comprising: a network interface configured to communicate with a user device and a third party system; a database configured to store information regarding the third party system; and a processing circuit comprising at least one processor and at least one memory, the at least one memory structured to store instructions that are executable to cause the at least one processor to: receive, via the network interface, third party information from the third party system, the third party information including a personalized identifier of a third party account of the third party system; store the third party information in the database; generate a graphical user interface (GUI), the GUI comprising a selectable graphical representation of a third party associated with the third party system, wherein the selectable graphical representation does not include the personalized identifier associated with the third party account; provide, via the network interface, the GUI to the user device; receive, via the network interface, a first user input to the GUI indicating a selection to transfer a resource to the third party; and cause a transfer of the resource from an account associated with the user device to the third party account associated with the third party system responsive to receiving the first user input.

At least one arrangement relates to a computer-implemented method, comprising: receiving, by a computing system, third party information from a third party system communicably coupled to the computing system via a network interface, the third party information including a personalized identifier of a third party account of the third party system; storing, by the computing system, the third party information in a database of the computing system; generating, by the computing system, a graphical user interface (GUI), the GUI comprising a selectable graphical representation of a third party associated with the third party system, wherein the selectable graphical representation does not include the personalized identifier associated with the third party; providing, by the computing system and via the network interface, the GUI to a user device communicably coupled to the computing system; receiving, by the computing system and via the network interface, a first user input to the GUI indicating a selection to transfer a resource to the third party; and causing, by the computing system, a transfer of the resource from an account associated with the user device to the third party account associated with the third party system.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment for facilitating making a donation while mitigating fraud, according to an example embodiment.

FIG. 2 is flow diagram of a method for making a donation, according to an example embodiment.

FIG. 3 is flow diagram of a method for making a donation, according to another example embodiment.

FIGS. 4A and 4B are graphical user interfaces presented to a customer for beginning a donation process, according to an example embodiment.

FIGS. 5A and 5B are graphical user interfaces presented to a customer for managing donations, according to example embodiments.

FIGS. 6A-6G are graphical user interfaces presented to a customer for selecting an organization for making a donation, according to example embodiments.

FIG. 7 is a graphical user interface presented to a customer when an organization is selected for making a donation, according to an example embodiment.

FIGS. 8A-8E are graphical user interfaces presented to a customer for donating to an organization, according to an example embodiment.

FIGS. 9A-9C are graphical user interfaces presented to a customer for analyzing donation history, according to an example embodiment.

### DETAILED DESCRIPTION

Referring generally to the figures, systems and methods for efficiently making a donation in a fraud-reduced and effective way are disclosed according to various embodiments herein. In some instances, the systems and methods described herein allow for charities and/or other organizations to register with a service provided by a provider computing system by receiving information associated with the organizations. The provider computing system may allow a user to effectuate a resource transfer (e.g., payment) to a registered organization without displaying a personalized token associated with the organization. Beneficially, the systems and methods described herein allow for a user to initiate a resource transfer to an organization or other recipient while concealing a personalized token thereby reducing a risk of fraudsters attempting to manipulate the personalized token and divert resources (i.e., steal) from the intended recipient. Furthermore, the systems and methods described herein generate and provide various user interfaces to a device of a user to complete donations to verified organizations, manage a user donation history, define and complete donation goals, export donation information for tax purposes, determine recommended organizations based on donation history, and various other functionalities described herein.

By way of example, if fraudsters have access to a personalized token of a recipient, such as a charity (e.g., @charityA, charityA@mail.com, etc.), the fraudsters may attempt to mimic the charity token by making slight and largely imperceptible changes to the legitimate token (e.g., @charityA1, chartyA@mail.com, etc.) in an attempt to divert donations intended for the charity to an illegitimate recipient. Accordingly, it is important to prevent these types of fraud before transactions can be made. The systems and methods described herein beneficially aid in the prevention of this type of fraud by concealing a personalized token of registered charities during a donation process. Technically and beneficially, the systems and methods described herein provide various technical solutions to problems and shortcomings of conventional resource transfer systems. For example, the systems and methods described herein operate in a non-conventional way by shielding a personalized token of a recipient to mitigate fraud during digital resource transfers, as compared to conventional techniques which do not shield the token and therefore allow fraudsters to potentially mimic the token. Furthermore, the systems and methods described herein operate in a non-conventional way by decoupling processing of the token and rendering a graphical user interface, thereby increasing processing power of conventional computing systems by correlating the concealed token and not rendering the token to a user device in real-time. By removing the rendered data element of the token on the graphical user interface, the generation of the graphical user interface may be more static. Further, the systems and methods described herein provide other additional advantages over conventional graphical user interfaces. For example, typical computer systems are limited in ways to organize displayed information on a graphical user interface. By automatically moving various graphical representations of a graphical user interface based on a total amount of resource transfers as described in greater detail herein, the systems and methods described herein provide a specific and particular manner of automatically displaying features to a user based on relevance of the feature in relation to a user's resource transfer habits. Additionally, by providing intelligent recommendations to a user device for transferring resources to a particular entity based on known information of a user, the systems and methods described herein may significantly reduce a click path of a user in comparison to conventional techniques by reducing an amount of inputs into a graphical user interface to identify a particular entity. Various other technical benefits and advantages are described in greater detail below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

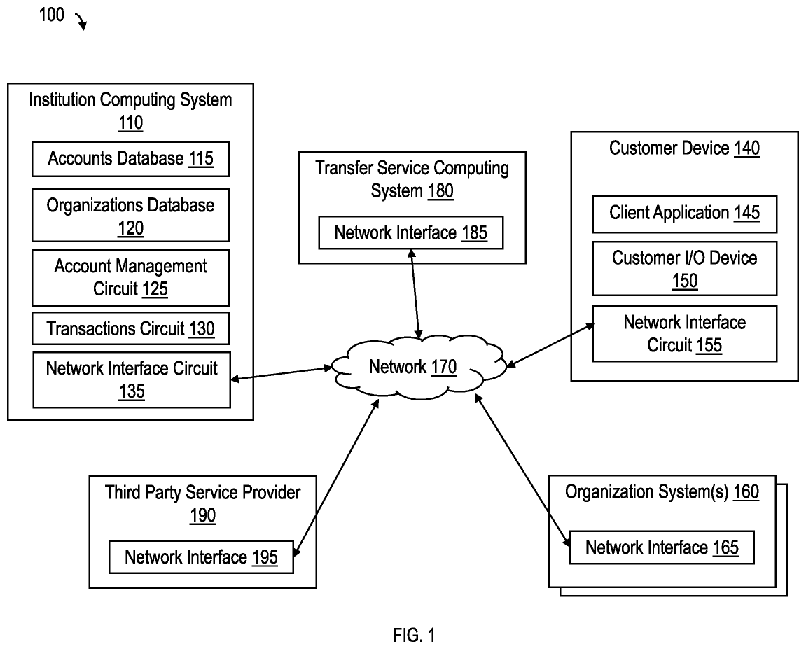

FIG. 1 is a diagram of a computing environment 100 for mitigating donation fraud, according to an example embodiment. As shown, the computing environment 100 includes one or more institution computing systems 110 associated with a provider (e.g., a financial institution), one or more customer devices 140 associated with one or more users, one or more organization systems 160, one or more transfer service computing systems 180, and/or one or more third party service providers 190. The institution computing system(s) 110, the customer device(s) 140, the organization system(s) 160, the transfer service computing system(s) 180, and/or the third party service provider(s) 190 are in communication with each other and are connected by a network 170, which may include one or more of the Internet, cellular network, Wi-Fi, Wi-Max, a proprietary banking network, or any other type of wired or wireless network or a combination of wired and wireless networks. As described herein, the computing environment 100 may be used to provide a user interface to the customer device 140 to efficiently make donations to various organizations while minimizing fraudulent activity.

For clarity, the following description will refer to an institution computing system 110, an organization system 160, a transfer service computing system 180, and a third party service provider 190. However, it will be understood that the following description of any of these devices and computing systems will be similarly applicable to any additional corresponding devices and computing systems (e.g., additional provider institution computing systems 110, organization systems 160, transfer service computing systems 180, or third party service providers 190) and that, in some embodiments, the computing environment 100 may include a plurality of any of the described devices and systems.

The institution computing system 110 is owned by, associated with, or otherwise operated by a provider institution (e.g., a bank or other financial institution) that maintains one or more accounts held by various customers (e.g., the customer associated with the customer device 140), such as demand deposit accounts, credit card accounts, receivables accounts, and so on. In some instances, the institution computing system 110, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the institution computing system 110 may be or may include various other devices communicably coupled thereto, such as, for example, desktop or laptop computers (e.g., tablet computers), smartphones, wearable devices (e.g., smartwatches), and/or other suitable devices.

In some embodiments, the institution computing system 110 includes an accounts database 115, an organizations database 120, an account management circuit 125, a transaction circuit 130, and a network interface circuit 135. In some instances, the network interface circuit 135 includes, for example, program logic that connects the institution computing system 110 to the network 170. The network interface circuit 135 facilitates secure communications between the institution computing system 110 and each of the customer device(s) 140, organization system(s) 160, transfer service computing system(s) 180, and third party service provider(s) 190. The network interface circuit 135 also facilitates communication with other entities, such as other banks, settlement systems, and so on. The network interface circuit 135 further includes user interface program logic configured to generate and present web pages to users accessing the institution computing system 110 over the network 170.

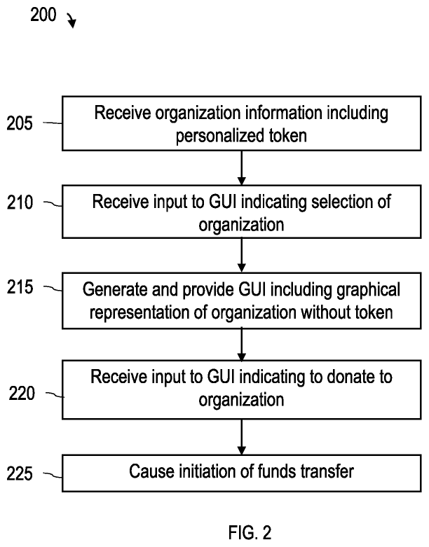

The account management circuit 125 is structured or configured to perform a variety of functionalities or operations to enable and monitor various customer activities (e.g., account processing, payment processing, etc.) in connection with organization information stored within an organizations database 120 and/or customer account information store within the accounts database 115. For example, the account management circuit 125 may be configured to monitor and/or pull transaction data and/or history from one or more customer accounts associated with the customer device 140. The transaction circuit 130 is structured or configured to perform various functionalities to enable transactions between the customer device 140, the transfer service computing system 180, and/or the organization system 160 (e.g., making a donation to an organization), account processing of historical transactions (e.g., tracking previous and/or recommended donations based on information received by the account management circuit 125), and/or a variety of other services associated with and/or provided by the financial institution, as described in greater detail with reference to FIGS. 2-9C.

In some instances, the account management circuit 125 is configured to, for each customer activity performed, automatically or nearly automatically pull account and/or organization information (e.g., from the organizations database 120 and/or from the accounts database 115) pertaining to the organization, the customer, and/or the customer account associated with the customer activity and to process the organization and/or customer information to provide the information to a customer on the customer device 140, as described herein. In some instances, the transaction circuit 130 is structured to, for each transaction and/or transfer service fund transfer performed by each customer of the provider, automatically pull customer account information associated with the customer (e.g., from the accounts database 115), as well as sender/recipient account information associated with the sender or recipient (e.g., from the transfer service computing system 180), associated with a particular transaction or transfer service fund transfer.

The organizations database 120 is structured or configured to retrievably store organization information associated with various organizations external to the financial institution. In some instances, the organization information may include a name, a phone number, an e-mail address, a physical address, a token (e.g., a tag or address associated with a particular account), account information, etc. of the organization. The accounts database 115 is structured or configured to retrievably store account information associated with various customers having accounts at the financial institution. In some instances, the account information may include a customer name, transaction history, a phone number, an e-mail address, a physical address, a token (e.g., a tag or address associated with a particular account), account information and/or number, etc. of the customer accounts.

In some instances, the account information may include transaction information, information pertaining to the type and corresponding capabilities of the given account, a service token (e.g., a phone number, an e-mail address, or a tag associated with a particular service account) associated with the customer account, etc. of the customer account. As will be described further herein, the account database 115 and the organizations database 120 are configured to be used by the account management circuit 125 and the transaction circuit 130 to identify various customer account information and organization information associated with various transfers and other activities to provide access to make and/or track donations while actively mitigating the risk of fraudulent activity.

The customer device 140 is owned, operated, controlled, managed, and/or otherwise associated with a customer (e.g., a customer of the financial institution). In some embodiments, the customer device 140 may be or may include, for example, a desktop or laptop computer (e.g. a tablet computer), a smartphone, a wearable device (e.g., a smartwatch), a personal digital assistant, and/or any other suitable computing device. In the example shown, the customer device 140 is structured as a mobile computing device, namely a smartphone.

In some embodiments, the customer device 140 includes one or more I/O devices 150, a network interface circuit 155, and one or more customer client applications 145. While the term “I/O” is used, it should be understood that the I/O devices 150 may be input-only devices, output-only devices, and/or a combination of input and output devices. In some instances, the I/O devices 150 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 150 further include one or more user interfaces (devices or components that interface with the customer), which may include one or more biometric sensors (such as a fingerprint reader, a heart monitor that detects cardiovascular signals, face scanner, an iris scanner, etc.).

The network interface circuit 155 includes, for example, program logic and various devices (e.g., transceivers, etc.) that connect the customer device 140 to the network 170. The network interface circuit 155 facilitates secure communications between the customer device 140 and each of the institution computing system 110, the organization system 160, the transfer service computing system 180, and/or the third party service provider 190. The network interface circuit 135 also facilitates communication with other entities, such as other banks, settlement systems, and so on.

The customer device 140 stores in computer memory, and executes (“runs”) using one or more processors, various customer client applications 145, such as an Internet browser presenting websites, text messaging applications (e.g., for sending MMS or SMS to the institution computing system 110, the organization system 160, the transfer computing system 180, and/or the third party service provider 190), and/or applications provided or authorized by entities implementing or administering any of the computing systems in computing environment 100.

For example, in some instances, the client applications 145 include a customer provider institution client application (e.g., a financial institution banking application) provided by and at least partly supported by the institution computing system 110. For example, in some instances, the client application 145 coupled to the institution computing system 110 may enable the customer to perform various customer activities (e.g., account management, tracking, etc.) and/or perform various transactions (e.g., transferring money to a particular organization, etc.) associated with one or more customer accounts of the customer held at the provider institution associated with the institution computing system 110 (e.g., account opening and closing operations, fund transfers, etc.).

In some instances, the client application 145 provided by the institution computing system 110 may additionally be coupled to the transfer service computing system 180 and/or to the third party service provider 190 (e.g., via one or more application programming interfaces (APIs) and/or software development kits (SDKs)) to integrate one or more features or services provided by the transfer service computing system 180. For example, in some instances, the institution computing system 110 may integrate a transfer service provided by the transfer service computing system 180 for transferring resources (e.g., funds) between users of the transfer service using transfer service tokens, as will be described further herein, into the client application 145. In some instances, the transfer service computing system 180 may alternatively and/or additionally provide the transfer service via a separate client application 145.

The organization system 160 is controlled by, managed by, owned by, and/or otherwise associated with an organization entity that is configured to transmit information to the institution computing system 110. Although not specifically shown, it will be appreciated that the organization system 160 may include a network interface 165, various databases (e.g., similar to the accounts database 115 and/or organizations database 120), an account management circuit, a transaction circuit, and/or other circuits in the same or similar manner to the other components of computing environment 100. As described herein, the organization entity may be one or more charities, non-profits, first responder entities, or other organizations capable of receiving resources. In the example shown, the organization entity is a charity organization. In other embodiments, a different entity may be the organization entity. Further, it should be appreciated that while only one entity is depicted, the system may include a plurality of organization entities. In one embodiment, all of the organization entities are charitable organizations. In other embodiment, at least one of the organization entities is a charitable organization and the remaining organizations are a different type of entities (e.g., for profit businesses, etc.).

The transfer service computing system 180 is controlled by, managed by, owned by, and/or otherwise associated with a transfer service entity (e.g., Zelle®) that is configured to enable real-time or nearly real-time transfers between users. As described herein and in one embodiment, the “transfer” is a payment or fund transfer. In some instances, the payment or fund transfer may include electronic or digital fund transfers.

In some instances, the transfer service entity may be a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the computing environment 100. As another example, the transfer service entity may be a third party vendor. As still another example, the transfer service entity may be provided by the provider institution, such that the provider institution performs both the operations described herein as being performed by the institution computing systems 110 and the operations described herein as being performed by the transfer service computing system 180.

In some embodiments, the transfer service computing system 180 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. Although not specifically shown, it will be appreciated that the transfer service computing system 180 may include a network interface 185, various databases (e.g., similar to the accounts database 115 and/or organizations database 120), an account management circuit, a transaction circuit, and/or other circuits in the same or similar manner to the other components of computing environment 100. In some instances, the network interface 185 may include user interface program logic configured to generate and present application pages, web pages, and/or various other data to users accessing the transfer service computing system 180 over the network 170.

The transfer service computing system 180 is configured to enable real-time or nearly real-time transfers between registered users of the transfer service. For example, in some instances, during a registration process, the transfer service computing system 180 is configured to receive one or more transfer service tokens (e.g., a Zelle® identifier), such as a phone number, an e-mail address, an alphanumeric tag, etc., to be associated with an entity (e.g., the customer, an organization, or any other user) registering for the transfer service.

As described herein, the transfer service computing system 180 may be configured to receive a registration request from the institution computing system 110, the organization system 160, and/or the customer device 140 to register the customer and/or the organization. In some instances, the registration request includes a desired transfer service token, account information, and identifying information associated with the customer and/or organization. Upon receiving the registration request, the transfer service computing system 180 may be configured to store the transfer service token, the account information, and the identifying information for the customer and/or the organization within a transfer service database and to link the transfer service token to the account information and the identifying information within the transfer service database to register the customer and/or the organization with the transfer service. In some embodiments, the transfer service computing system 180 may be configured to exchange data with one or more third party service providers 190 to verify an identity of an entity and/or to store information of the entity.

Once the transfer service token, the account information, and the identifying information for the organization and/or customer have been stored and linked within the transfer service database, the transfer service computing system 180 may be configured to, upon receipt of a transfer request (e.g., received from the provider institution computing system 110, the organization system 160, or the customer device 140), query the transfer service database to retrieve the corresponding account information and identifying information associated with recipient and sender transfer service tokens included in the requested transfer. In some embodiments, the transfer service computing system 180 may additionally or alternatively be configured to transmit an API call to a server of the third party service provider 190 to retrieve corresponding information associated with the recipient. Once the corresponding account information is successfully retrieved by the transfer service computing system 180, the transfer service computing system 180 may be configured to initiate a transfer (e.g., of funds) from an account associated with the sender to an account associated with the recipient.

In some instances, the transfer service computing system 180 is configured to provide (e.g., through its own client application or through integration with a client application of another entity, such as a banking application) at least some of the functionality depicted in the figures and described herein. For example, in some instances, as discussed above, at least some of the functionality performed by the transfer service computing system 180 is integrated within a banking application (e.g., one of the client applications 145) provided by the institution computing system 110 to the customer device 140. For example, in some instances, the transfer service computing system 180 includes one or more APIs and/or SDKs that securely communicate with the institution computing system 110 and allow for various functionality performed by the transfer service computing system 180 to be embedded within the client application 145 provided by the institution computing system 110 to the customer device 140.

The third party service provider 190 is controlled by, managed by, owned by, and/or otherwise associated with a third party service entity (e.g., the Early Warning Service (“EWS”), credit agencies (e.g., TransUnion, Equifax, Experian, etc.), or other third-party service providers used by the financial institution) and is configured to receive and/or transmit data with the institution computing system 110 and/or other systems connected to the network 170. In some implementations, the transfer service computing system 180 is at least partially owned by or associated with the third party service provider 190. In some implementations, the transfer service computing system 180 and the third party service provider 190 are owned and associated with separate entities.

In some embodiments, the third party service provider 190 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. Although not specifically shown, it will be appreciated that the third party service provider 190 may include a network interface 195, various databases (e.g., similar to the accounts database 115 and/or organizations database 120), an account management circuit, a transaction circuit, and/or other circuits in the same or similar manner to the other components of computing environment 100. In some instances, the network interface 195 may include user interface program logic configured to generate and present application pages, web pages, and/or various other data to users accessing the transfer service computing system 180 and/or third party service provider 190 over the network 170.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 2, a flow diagram of a method 200 for allowing a customer to make donations to various third parties (organizations) is shown, according to an example embodiment. Various operations of the method 200 may be conducted by the computing environment 100 and particularly parts thereof (e.g., the institution computing system 110, the customer device 140, the organization system 160, the transfer service computing system 180, and/or the third party service provider 190).

The institution computing system 110 may initiate the method 200 responsive to a customer registering for and/or launching the client application 145 of the customer device 140. In some implementations, the network interface circuit 135 may be structured to generate and provide one or more user interfaces to the customer device 140 to enable one or more portions of the method 200. For example, the institution computing system 110 (e.g., network interface circuit 135) may be configured to generate and present web pages to customers accessing the institution computing system 110 over the network 170 via the one or more client applications 145 of the customer device 140. The user interface may be a website or webpage, mobile application, and so forth. In some embodiments, the network interface circuit 135 may be hard coded into the client application 145 and configured to establish and present the user interface to the customer device 140 responsive to a customer accessing the client application 145. In some embodiments, the computing system 110 (e.g., network interface circuit 135) may be configured to establish and present the user interface to the customer device 140 responsive to the user registering as a new user with the institution computing system 110 (e.g., by providing log-in credentials or other authentication information to the institution computing system 110 via the customer device 140). In some embodiments, network interface circuit 135 may be configured to establish and present the user interface to the customer device 140 responsive to the user registering as a new user with the transfer service computing system 180 (e.g., by providing log-in credentials or other authentication information to the transfer service computing system 180 via the customer device 140, as described herein). In some embodiments, the network interface circuit 135 may be configured to establish and present the user interface to the customer device 140 responsive to transmitting an invitation to the user for registering as a new user, the user providing authentication information, and the user consenting to the terms of use for the user interface. It should be understood that while the user interfaces described herein are described separately, the user interfaces described herein can be displayed on the same display (e.g., of the customer device 140) and can be dynamically updated to generate the various interfaces described herein (e.g., one user interface updates responsive to inputs to create multiple configurations of the user interface).

At step 205, the institution computing system 110 (e.g., the transaction circuit 130) receives organization information from one or more organization systems 160. In some implementations, the transaction circuit 130 may receive one or more data packets (e.g., digitalized versions of one or more documents, etc.) including the organization information during a registration process. For example, the transaction circuit 130 may receive the organization information responsive to transmitting a request for information to the organization system 160 for registering the organization of the organization system 160 with a service of the institution computing system 110 and/or the transfer service computing system 180. The request may include, for example, a predefined file format for a user of the organization to complete and transmit back to the institution computing system 110. The transaction circuit 130 may extract the organization information from the predefined file format. By way of example, the transaction circuit 130 may transmit a message (e.g., email, SMS, notification, etc.) to the organization system 160. The message may include one or more manual inputs for a user to complete to provide the organization information (e.g., a selection of a category type, name, address, tokens and/or identifiers, employer identification number (EIN), a bank routing number, a bank account number, and/or other various information). The transaction circuit 130 may receive the organization information responsive to the organization system 160 transmitting the completed message back to the institution computing system 110 to complete the registration. The received organization information may include at least one personal identifier associated with the organization system 160 and/or the transfer service computing system 180. The transaction circuit 130 may cause the organization information to be stored in the organizations database 120.

In some implementations, the organization information may include a selection of a finite number of category types (e.g., animals, arts, children, education, emergency relief, environment, health, international, poverty, public benefit, military, religion, social services, other, etc.). In some implementations, the transaction circuit 130 may use one or more machine learning models (e.g., stored in the organizations database 120) to receive or extract the organization information, such as the category. For example, the machine learning models may be trained using historical data stored within the organizations database 120. The various machine learning models may include neural networks (e.g., convolutional neural networks, deep neural networks), Support Vector Machines (SVMs), Random Forests, or the like. The machine learning models may be trained on known input-output pairs given known inputs. For example, the machine learning models may be trained to predict an organization category based on a plurality of known inputs and outputs (e.g., keyword associations, transaction history, etc.) By way of example, the transaction circuit 130 may receive organization information from the organization system 160 during a registration process. The transaction circuit 130 may extract a plurality of instances of the words “kitten” and “rescue” provided by the organization. The transaction circuit 130 may use the one or more machine learning models to determine, based on previous organization information of other organizations, that the words “kitten” and “rescue” are associated with the category of animals. The transaction circuit 130 may store the organization information within the organizations database 120 (e.g., as known inputs and outputs to facilitate training the machine learning models).

The transaction circuit 130 may receive organization information from a plurality of organization systems 160 each associated with a unique organization. The transaction circuit 130 may store each of the received information within the organizations database 120. In some implementations, the transaction circuit 130 may store and/or embed one or more additional data elements with each set of organization information from each organization system 160. For example, the transaction circuit 130 may flag the received organization information as an organization (e.g., a charity, a non-profit, a small business, etc.) and/or may indicate a category of the organization (e.g., animals, health, education, environment, adolescence, mental health, etc.) within the organizations database 120. For example, the transaction circuit 130 may flag the organizations and/or indicate a category by storing one or more data elements (e.g., unique identifiers) with each organization entity to indicate the organization is capable of receiving donations.

In some implementations, the transaction circuit 130 may verify the organization information prior to and/or simultaneously with requesting the organization information of the organization system 160. For example, the transaction circuit 130 may be structured to transmit API calls only with known and trusted organization sites and/or APIs (e.g., secured websites having an “https” address, a predetermined listing of known organization sites or exposed APIs, etc.). The transaction circuit 130 may verify the organization information responsive to receiving information from the known websites and/or APIs.

In some implementations, the transaction circuit 130 may verify or authorize an organization based on the received organization information after receiving the organization information. For example, the transaction circuit 130 may transmit the received organization information to at least one third party service provider 190, such as the EWS, a credit bureau, or a third-party identification verification service. The third party service providers 190 may cross-reference known or previously verified information associated with the organization to determine if all of the information provided by the organization matches the known or previously verified information. In some implementations, the transaction circuit 130 may additionally or alternatively poll the organizations database 120 to compare the received organization information with known or previously verified information associated with the organization. If the provided organization information matches known or previously verified information associated with the organization, the user information is verified. If the provided organization information does not match known or previously verified information associated with the organization, the transaction circuit 130 may not approve the information and/or may request additional information of the organization system 160. In some arrangements, a representative of the organization may be required to meet in person with an analyst of the financial institution at a branch to verify the organization's identity in person.

In some implementations, the transaction circuit 130 may transmit the received organization information, including a personalized identifier such as a transfer service token, to the transfer service computing system 180 to register the organization. For example, as described herein, the personal identifier may include one or more transfer service tokens (e.g., a Zelle® identifier), such as a phone number, an e-mail address, an alphanumeric tag, etc., to be associated with an entity (e.g., an organization) registering for the transfer service. In some implementations, the transaction circuit 130 may transmit the received organization information to the transfer service computing system 180 to register the organization. For example, the transaction circuit 130 may cause the transfer service computing system 180 to associate the bank account information, name, address, and/or other information with the organization to be linked to the corresponding received transfer service token(s) for registering the organization with the transfer service.

In some implementations, the transaction circuit 130 may be configured to determine, based on the received organization information including a bank account routing number, that the bank account of the organization may not be capable of receiving or sending payments via the transfer service computing system 180 (e.g., by comparing the receiving bank account routing number with a stored list of bank account routing numbers that are registered with the transfer service computing system 180). Responsive to determining that the bank account of the organization may not be capable of receiving or sending payments via the transfer service computing system 180, the transaction circuit 130 may transmit a request to the organization system 160 for the organization system to register and/or pay a registration fee to receive donations via the transfer service computing system 180 even if the bank of the organization is not registered with the transfer service computing system 180. For example, the request may indicate that the organization system 160 may register to receive donations via an automated clearing house (ACH) transaction from a holding account of the transfer service computing system 180.

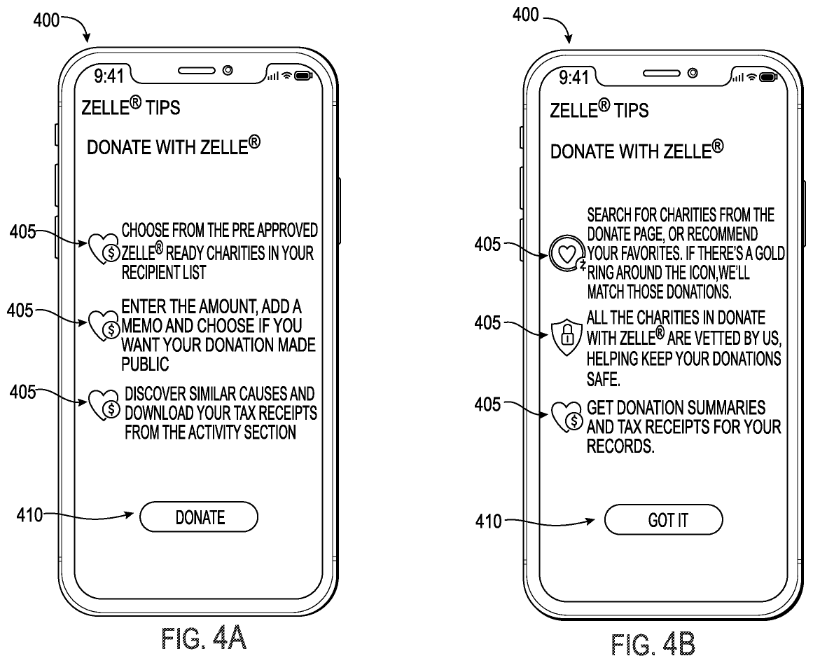

At step 210, the transaction circuit 130 receives an input to a graphical user interface displayed on the customer device 140. For example, FIGS. 4A and 4B depict examples of a first user interface 400 presented to a customer (e.g., via the customer device 140). As described herein, the account management circuit 125 and/or the transaction circuit 130 may cause the network interface circuit 135 to generate and provide the first user interface 400 responsive to a customer opening the client application 145 of the customer device 140 and/or the customer opening an account with the institution computing system 110. The account management circuit 125 and/or the transaction circuit 130 may cause the network interface circuit 135 to generate and provide the first user interface 400 responsive to a customer registering and/or accessing the transfer service computing system 180 via the client application 145 (e.g., responsive to receiving log-in credentials and/or information to register at the transfer service computing system 180 as described herein).

The network interface circuit 135 may generate the first user interface 400 for a customer to begin making a donation to one or more organizations via the transfer service computing system, institution computing system 110, and/or third party service providers 190 (e.g., EWS). The first user interface 400 may display one or more icons 405 and/or features that the customer can use via the user interface 400. For example, the icons 405 may include one or more portions of texts, sounds, videos, images, or other features that indicate how to use the client application 145. The icons 405 may indicate, for example, various functionalities of the client application 145 including how to complete a donation (e.g., choose from pre-approved organizations, search for organizations, enter an amount, discover similar organizations, and/or download tax receipts as described herein).

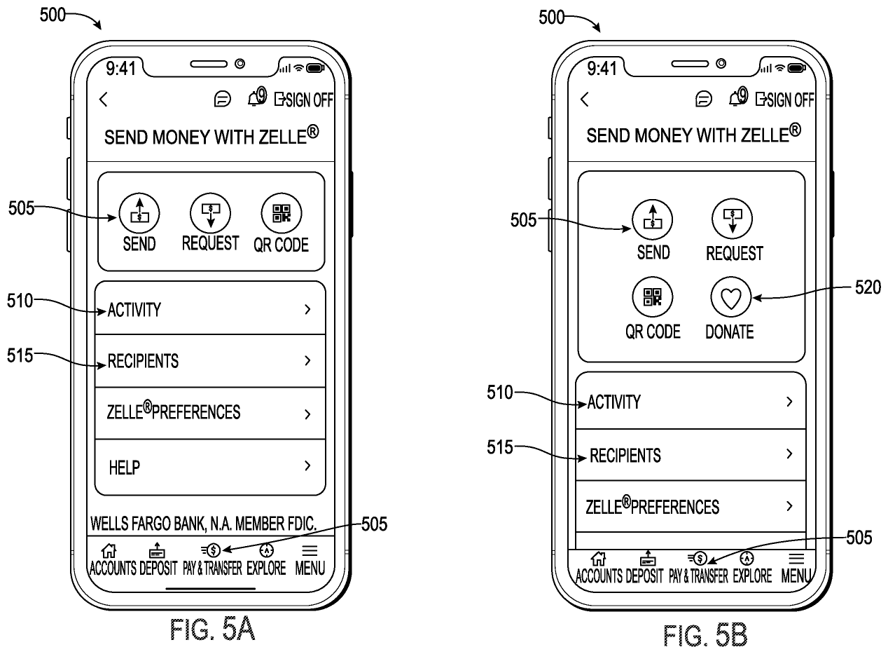

The first user interface 400 may include at least one selectable donate icon 410 that allows a customer to begin the donation process. For example, the customer device 140 may be configured to receive a manual user input to the donate icon 410 (e.g., via a touch on a touch screen, a click of a cursor, etc.). The network interface circuit 155 of the customer device 140 may be structured to transmit the indication of the selection of the donate icon 410 to the institution computing system 110 responsive to receiving the user input. For example, the transaction circuit 130 may receive the indication of the selection of the donate icon 410 responsive to the user input. FIGS. 5A and 5B show example second user interfaces 500 generated by the network interface circuit 135 responsive to, for example, the transaction circuit 130 receiving an input to the donate icon 410.

The second user interface 500 may be or may include a home page that allows a customer to manage transactions, donations, and other activity associated with an account of the customer. FIG. 5A depicts the user interface 500 according to one embodiment. Referring to FIG. 5A, the second user interface 500 may include at least one payment button 505, at least one activity button 510, and at least one recipients button 515. As described in greater detail herein, an input to the payment button 505 may indicate a customer wishes to transmit a payment to a recipient (e.g., an organization, such as a charity), an input to the activity button 510 may indicate that a customer wishes to view and/or manage activity of a customer account, and an input to the recipients button 515 may indicate a customer wishes to view recipients of previous payments. FIG. 5B shows a similar user interface 500, but including a donate button 520. An input to the donate button 520 may indicate that a customer wishes to donate to a charity.

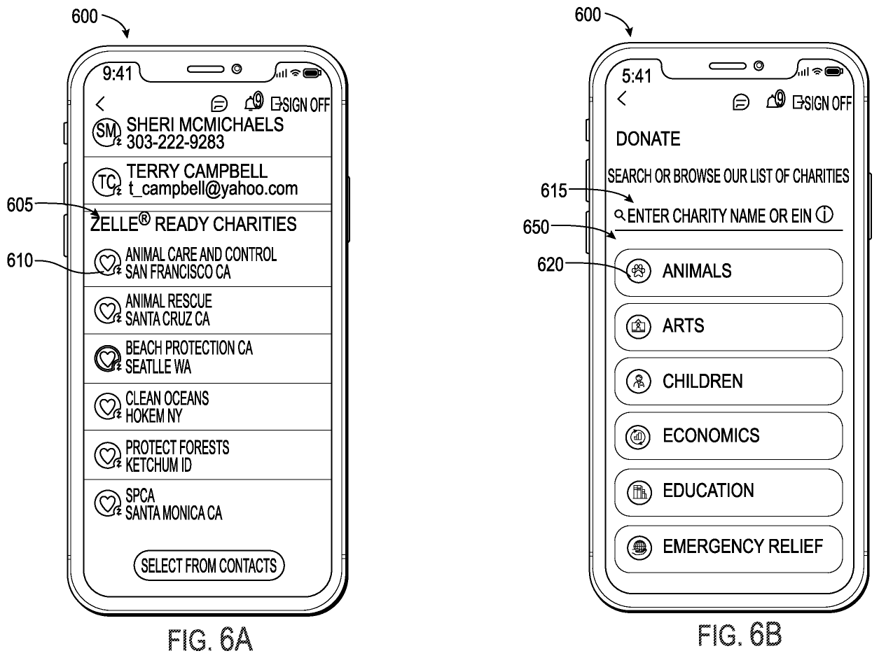

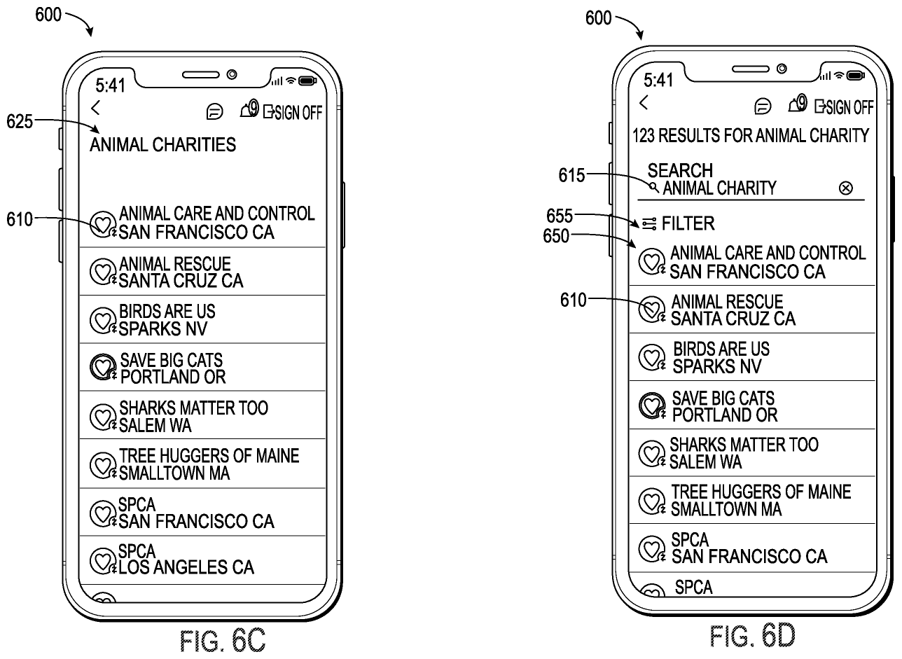

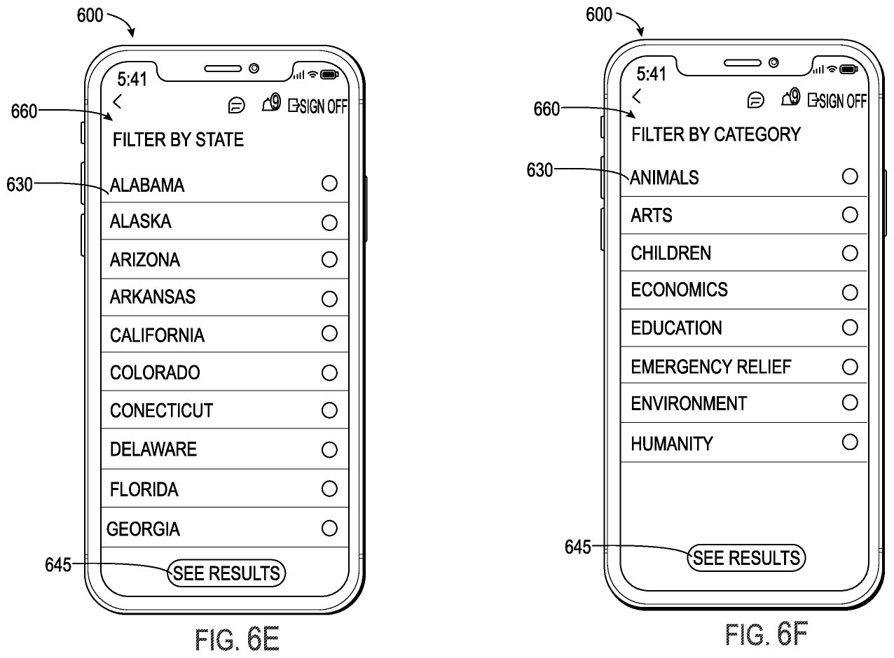

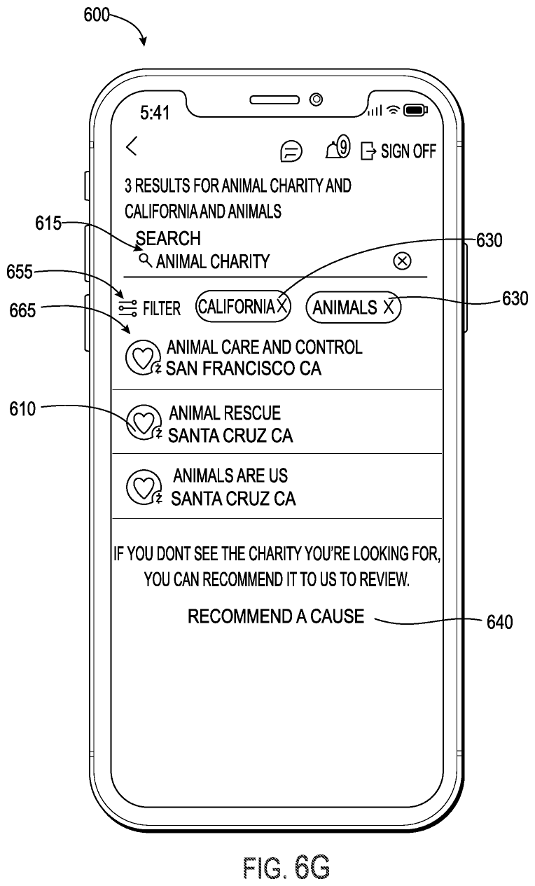

FIGS. 6A-6G show example third user interfaces 600 generated by the network interface circuit 135 responsive to, for example, the customer device 140 receiving an input to the payment button 505 and/or the donate button 520. For example, responsive to receiving an input to the payment button of FIG. 5A or 5B, the transaction circuit 130 may cause the network interface circuit 135 to generate and provide the third user interface 600 displayed in FIG. 6A. The third user interface 600 may include a list 605 of verified organizations (e.g., charities). The list 605 may indicate that the organizations are pre-approved by the financial institution. For example, the list 605 may include one or more texts (e.g., “approved charities”), images (e.g., predetermined icons), and/or other features that indicate the tokens and accounts associated with the organizations are authenticated, as described herein. For example, the transaction circuit 130 may cause the network interface circuit 135 to render a plurality of graphical representations 610 each associated with an organization. The graphical representation 610 may include an icon that indicates the organization is verified and/or approved by the institution computing system 110 and/or various information of each organization (e.g., name, location, category, or other organization information received at step 205). In some implementations, the graphical representation 610 may include one or more images of a heart, a dollar sign, and/or other images that indicate the organization is an approved charity, non-profit, or other organization accepting donations.

In some implementations, the graphical representation 610 may include one or more features indicating an entity (e.g., the financial institution associated with the institution computing system 110, a third party entity, etc.) will match a donation to the organization. For example, the graphical representation 610 may include an outline of a predetermined color (e.g., red, yellow, green, etc.) that indicates an entity will match a donation to the organization associated with the graphical representation 610. In some implementations, the graphical representation 610 may not include an indication that an entity will match the donation. For example, in some implementations, the transaction circuit 130 may transmit a notification to the customer device 140 responsive to a user making a donation, as described herein, indicating an entity will match the donation (e.g., a surprise match). In some implementations, the transaction circuit 130 may transmit a notification to the customer device 140 indicating that an entity will round out a donation responsive to receiving an indication to make a donation (e.g., round to the nearest $1, the nearest $10, etc.).

Responsive to receiving an input to the donate button 520 of FIG. 5B, the transaction circuit 130 may cause the network interface circuit 135 to generate and provide the third user interface 600 displayed in FIG. 6B. The third user interface 600 may include a search box 615, a list 650 of categories, and one or more graphical representations 620 of the categories. For example, the transaction circuit 130 may aggregate organizations together based on the received organization information of each organization into various organization categories (e.g., animals, arts, children, economics, education, emergency relief, environment, etc.). The transaction circuit 130 may cause the network interface circuit 135 to render the graphical representations 620 of each category based on the grouping. Each graphical representation 620 may include the category name, an image, a video, and/or other indications of the category. For example, the transaction circuit 130 may assign a predetermined image uploaded and/or stored in the institution computing system 110 responsive to receiving the organization information including the predetermined categories. Each of the graphical representations 610 of individual organizations, the graphical representations 620 of organization categories, and the search box 615 can receive a user input indicating the customer wishes to donate to a selected organization (e.g., by selecting a graphical representation 610 of an organization), browse organizations of a selected category (e.g., by selecting a graphical representation 620 of a category), or search for a specific organization (e.g., by selecting the search box 615).

FIG. 6C shows an example of the third interface 600 displayed to the customer device 140 responsive to the transaction circuit 130 receiving an input to a graphical representation 620 of a category shown in FIG. 6B (e.g., indicating a selection of the “Animal” category). For example, responsive to receiving the input to the graphical representation 620, the transaction circuit 130 may cause the network interface circuit 135 to generate and provide the user interface 600 displayed in FIG. 6C. The user interface 600 may include a list 625 of organizations grouped within the selected category. The list 625 may include the graphical representations 610 of individual organizations as shown in described with reference to FIG. 6A. For example, the list 625 of organizations displayed in FIG. 6C may be similar to the list 605 of organizations displayed in FIG. 6A, except only displaying organizations grouped within the selected category.

FIG. 6D shows an example of the third interface 600 displayed to the customer device 140 responsive to the transaction circuit 130 receiving an input to the search box 615 shown in FIG. 6B (e.g., indicating to search for “Animal Charity”). For example, responsive to receiving the input to the search box 615, the transaction circuit 130 may cause the network interface circuit 135 to generate and provide the user interface 600 displayed in FIG. 6D. The user interface 600 may include a list 650 of organizations associated with the input to the search box 615. For example, the transaction circuit 130 may be structured to parse the received organization information stored in the organizations database 120 for the input to the search box and extract any organizations having information that matches the input. The list 650 of organizations associated with the input may include the graphical representations 610 of individual organizations as shown in described with reference to FIG. 6A. For example, the list 650 of organizations displayed in FIG. 6D may be similar to the list 605 of organizations displayed in FIG. 6A, except only displaying organizations associated with the input to the search box 615. The user interface 600 may include various other information including, but not limited to, a numerical amount of results found based on the input to the search box 615. For example, responsive to receiving an input to filter by state, the transaction circuit 130 may cause the network interface circuit 135 to generate and provide the user interface 600 displayed in FIG. 6E and responsive to receiving an input to filter by category, the transaction circuit 130 may cause the network interface circuit 135 to generate and provide the user interface 600 displayed in FIG. 6F.

The user interface 600 shown in FIG. 6D may include at least one filter button 655. The filter button 655 may allow a customer to drill down (e.g., narrow) the list 650 of organizations. For example, the transaction circuit 130 may cause the network interface circuit 135 to render a plurality of filter categories responsive to receiving an input to the filter button 655. The plurality of filter categories may include a finite number of predetermined filter categories including, but not limited to, location of an organization (e.g., city, state, country, etc.), organization category type as described herein, type of organization (e.g., charity, non-profit, medical center, etc.), and/or various other filter categories based on the received organization information. For example, FIGS. 6E and 6F show example third user interfaces 600 displayed to the customer device 140 responsive to receiving an input to a filter category (e.g., to filter by location as depicted in FIG. 6E and to filter by category type as depicted in FIG. 6F).

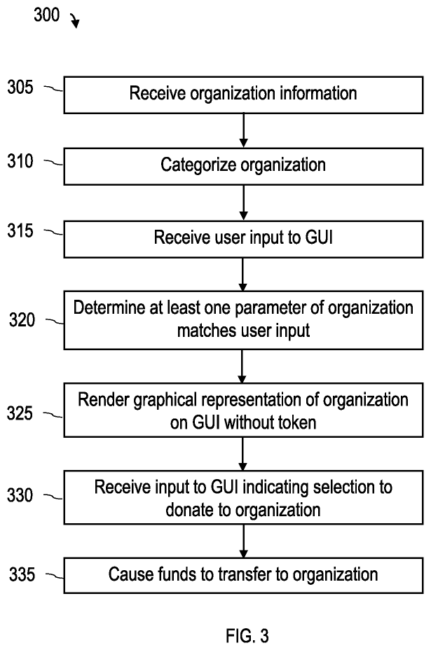

The user interfaces of FIGS. 6E and 6F may include a list 660 of filter selections, one or more graphical representations 630 of a filter selection, and/or a results button 645. For example, the graphical representation 630 of each filter selection may include text, images, videos, or other selectable features that can receive a user input to select the selection (e.g., choose to filter by a specified parameter). The results button 645 may include a selectable feature for a user to receive a list of organizations based on the filter selections. For example, the transaction circuit 130 may receive in input to one or more graphical representations 630 of filter selections and a user input to the results button 645. Responsive to receiving the inputs, the transaction circuit 130 may cause the network interface circuit 135 to generate and render the user interface 600 displayed in FIG. 6G. As shown in FIG. 6G, the updated user interface 600 may include a graphical representation 630 of the selected filter selections and a list 665 of organizations associated with the input to the search box 615 and the filter selections. For example, responsive to receiving the selection of the filter selections, the transaction circuit 130 may parse the list 650 of organizations associated with the input to the search box 615 and extract any organizations having information that matches the filter selections. The list 665 of organizations associated with the input and selections may include the graphical representations 610 of individual organizations as shown and described with reference to FIG. 6A. For example, the list 665 of organizations displayed in FIG. 6G may be similar to the list 605 of organizations displayed in FIG. 6A, except only displaying organizations associated with the input to the search box 615 and the filter selections. In some implementations, the transaction circuit 130 may recommend one or more organizations, as described in greater detail with reference to FIG. 3, responsive to determining that no organizations match the input to the search box 615 and/or the filter selections.

In some implementations, the user interface 600 may include at least one recommendation input 640, as depicted in FIG. 6G. For example, a customer may provide an input to the recommendation input 640 responsive to determining the user interface 600 does not display a particular organization. Responsive to receiving an input to the recommendation input 640, the transaction circuit 130 may request additional information by causing the network interface circuit 135 to render a prompt to the user interface 600. For example, the prompt may include one or more selectable features for a customer to input predetermined organization information including, but not limited to, a name of the organization, a location of the organization, a type and/or category of the organization, among other information. Responsive to receiving the recommended organization information, the transaction circuit 130 may verify the received information by requesting information from the organization directly and comparing the received organization information from the organization system 160 with the received organization information from the customer device 140 and/or by transmitting the information to an external provider system for verification. The transaction circuit 130 may store the information within the organizations database 120 to add the organization to the stored organizations list in the database 120.

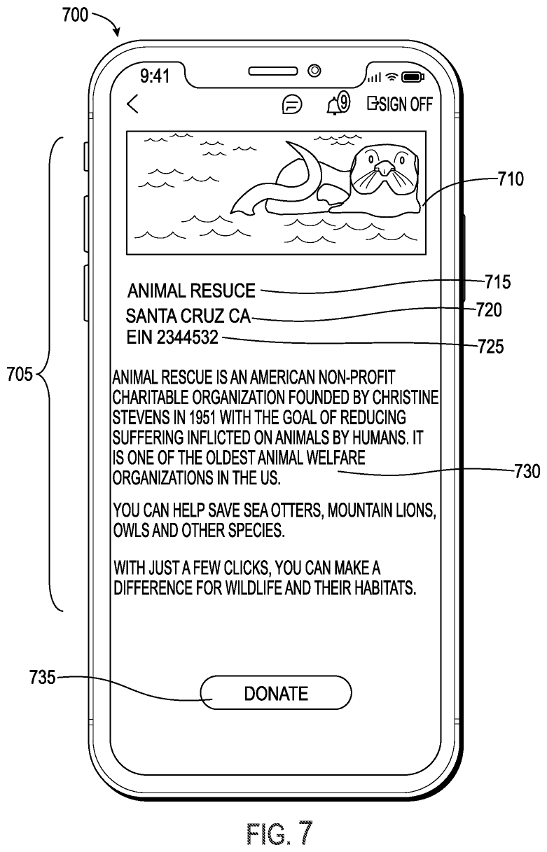

Referring back to FIG. 2, the transaction circuit 130 causes the network interface circuit 135 to generate and provide a user interface including a graphical representation of an organization without a personalized identifier (e.g., transfer service token) responsive to receiving a user input at step 215. For example, FIG. 7 shows an example fourth user interface 700 displaying at least one graphical representation 705 of a selected organization. In some implementations, the transaction circuit 130 may cause the network interface circuit 135 to generate and provide the fourth user interface 700 to the customer device 140 responsive to receiving a user input to one of the graphical representations 610 of the organizations depicted in FIG. 6A, 6C, 6D, or 6G. For example, responsive to receiving a selection of an organization to make a donation (e.g., by receiving a user input to a graphical representation 610), the transaction circuit 130 may pull various information for the organization and cause the network interface circuit 135 to render the information in the graphical representation 705.

The graphical representation 705 may include an image 710 associated with the organization, a name 715 of the organization, a location 720 of the organization, an EIN 725 of the organization, a description 730 of the organization, and/or various other information received. In some implementations, the image 710 may include one or more predetermined stock images stored in the organizations database 120 based on the category of the organization. In some implementations, the image 710 may include one or more images stored in the organizations database 120 that is directly associated with the organization (e.g., received as organization information during a registration process). The location 720 of the organization may include a city, state, and/or country. The description 730 of the organization may include one or more predetermined descriptions associated with a category and/or may include information associated with the organization (e.g., received during a registration process). The graphical representation 705 may not include any tokens associated with the organization. For example, the transaction circuit 130 may be structured to maintain the registered transfer service token of the organization stored within the organizations database 120 such that the token is not rendered on the user interface 700, as described in greater detail herein.

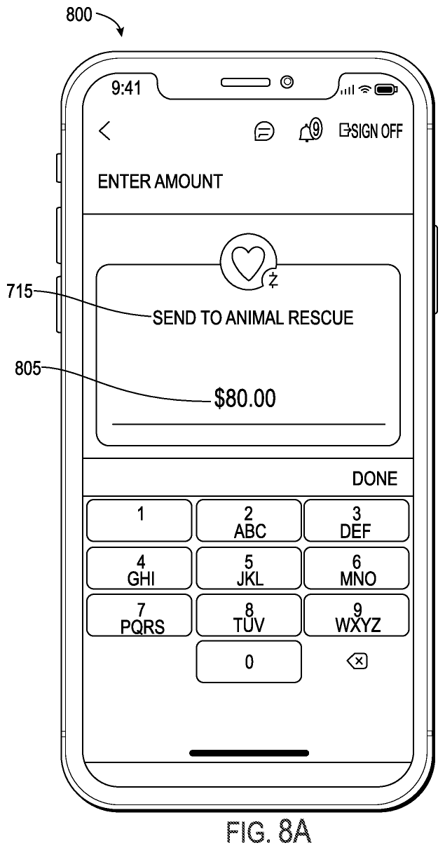

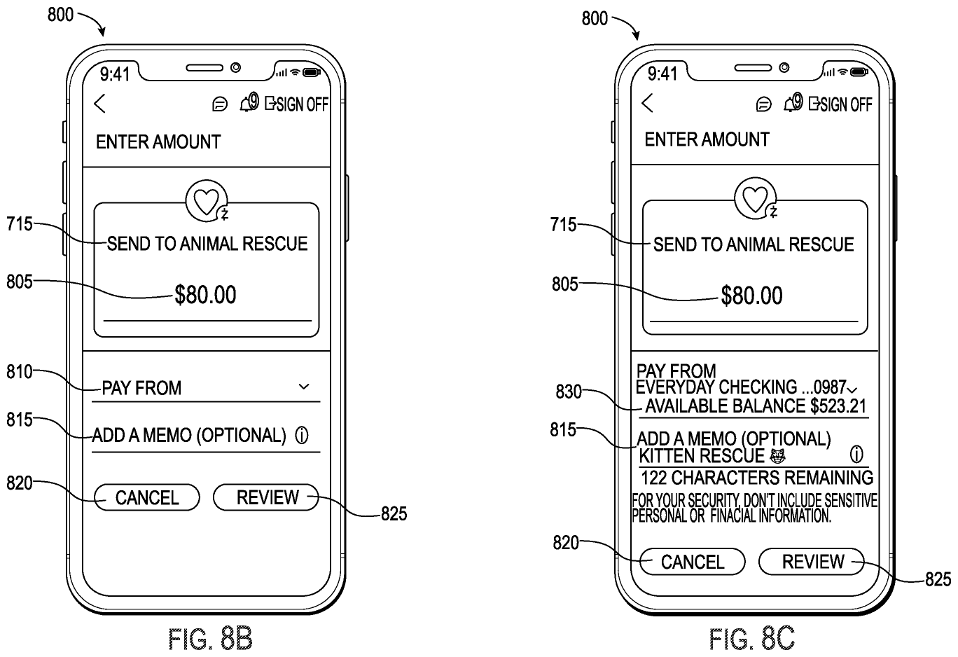

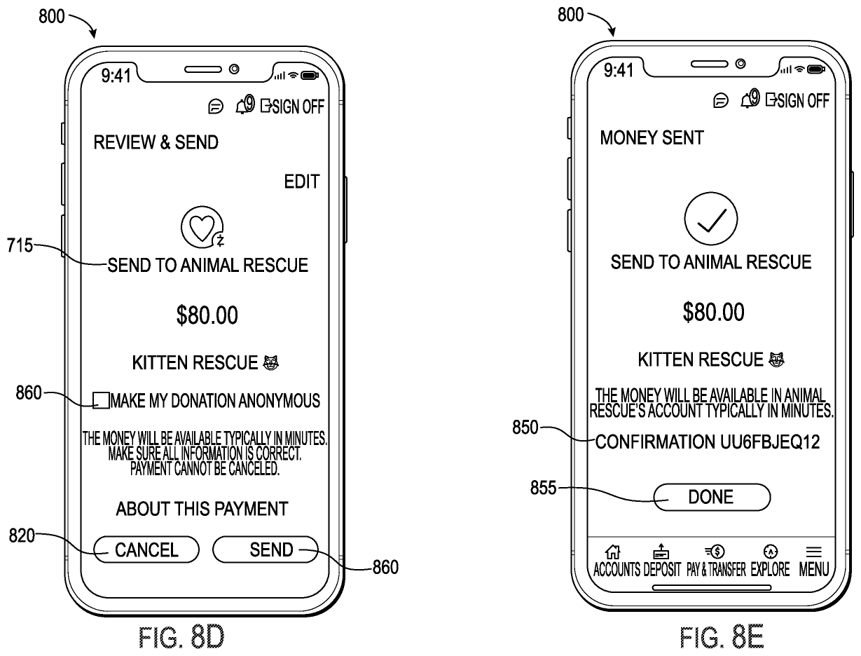

Referring back to FIG. 2, the transaction circuit 130 receives a user input to a user interface indicating to donate to an organization at step 220. For example, the fourth user interface 700 may include at least one donate button 735. An input to the donate button 735 may indicate that a customer wishes to donate to the charity displayed in the graphical representation 705. Responsive to receiving an input to the donate button 735, the transaction circuit 130 may cause the network interface circuit 135 to generate and provide a user interface prompting the customer to provide information to complete the donation. For example, FIGS. 8A-8E show example fifth user interfaces 800 that prompt a customer to complete a donation. The transaction circuit 130 may cause the network interface circuit 135 to generate and provide the fifth user interface 800 responsive to receiving an input to the donate button 735.

Referring to FIG. 8A, the user interface 800 may include one or more portions of the graphical representation 705 of the organization, such as the name 715 of the organization. The transfer service token is not displayed on the user interface 800 at any point during completion of the donation. The user interface 800 may include an amount input box 805 that is capable of receiving a user input indicating a specific dollar amount a customer wishes to donate to the organization. In some implementations, responsive to receiving an input to the amount input box 805 (and/or an input to the user interface 800 indicating the amount is complete), the transaction circuit 130 may cause an initiation of a transaction between the customer and the organization, as will be described herein. In some implementations, responsive to receiving an input to the amount input box 805 (and/or an input to the user interface 800 indicating the amount is complete), the transaction circuit 130 may cause the network interface circuit 135 to generate and provide the updated user interface 800 depicted in FIGS. 8B and 8C. The user interface 800 may include a sending account input 810, a memo input box 815, a cancel button 820, and/or a review button 825. Responsive to receiving an input to the sending account input 810, the network interface circuit 135 may render one or more account numbers associated with the customer for initiating the transaction. The transaction circuit 130 may receive a user input to the sending account input 810 indicating a selection of an account to send the transaction from (e.g., a sending account). In some implementations, the transaction circuit 130 may receive a user input to the sending account input 810 indicating a selection between an individual (e.g., personal) account and a business account. In some implementations, as shown in FIG. 8C, a selection of the sending account may cause the network interface circuit 135 to render an available balance 830 of the sending account. Responsive to receiving an input to the memo input 815, the transaction circuit 130 may be structured to transmit the input along with the transaction at completion of the transaction. Responsive to receiving an input to the cancel button 820, the transaction circuit 130 may cancel the transaction and cause the network interface 135 to render an updated user interface (e.g., display the user interface 700 again).

Responsive to receiving an input to the review button 825, the transaction circuit 130 may cause the network interface circuit 135 to generate and provide an updated fifth user interface 800 shown in FIG. 8D. The updated user interface 800 may include a summary of the donation. For example, the user interface 800 may include one or more portions of the graphical representation 705 (e.g., the name 715 of the organization), an amount of the donation, a memo, an anonymous button 860, and a send button 860. Responsive to receiving an input to the anonymous button 860, the transaction circuit 130 may determine to initiate the transaction with a request to not display a name of the customer. In some implementations, the user interface 800 may additionally or alternatively include an input to receive a name of the customer and/or another user for the customer to donate on behalf of to include with the transaction.

Referring back to FIG. 2, the transaction circuit 130 causes an initiation of a transfer of funds at step 225. For example, responsive to receiving an input to the send button 860 displayed in FIG. 8D, the transaction circuit 130 may initiate a transaction between a sender (e.g., the customer of the customer device 140) and a recipient (e.g., the organization). To initiate the transaction, the transaction circuit 130 may be structured to transmit transaction information to a third party service provider 190, such as EWS. For example, the transaction information may include, among other information, the name of the organization and an amount of the transaction. The transaction circuit 130 may cause the third party service provider 190 to parse stored information and determine the registered token associated with the received name to initiate the transfer of funds in the amount of the transaction. In some implementations, the transaction circuit 130 may receive transaction information from the third party service provider 190 to complete the transfer of funds (e.g., an indication of a confirmation of the registered token such that the institution computing system 110 may cause the funds to be transferred).

Responsive to receiving the input to the send button 860, the transaction circuit 130 may cause the network interface circuit 135 to generate and provide an updated fifth user interface 800 shown in FIG. 8E to the customer device 140. The updated user interface 800 may include a confirmation that the payment has been initiated and/or completed. In some implementations, the user interface 800 may include a confirmation number 850 (e.g., a unique identifier) associated with the transaction. The user interface 800 may include a complete button 855. Responsive to receiving a user input to the complete button 855, the network interface 135 may provide another user interface to the customer device 140 (e.g., user interface 700 shown in FIG. 7).

Allowing completion of a donation without providing or displaying the transfer service token to a user may have numerous advantages over conventional techniques. For example, by providing donation capabilities where the token associated with the organization is not shown, the systems and methods described herein may facilitate decreasing the risk of fraud, as fraudsters cannot attempt to mimic the token of the organization and therefore divert funds earmarked for the organization to their own accounts.

In some implementations, the institution computing system 110 may generate and provide intelligent recommendations of an organization to a user of the customer device 140. For example, referring to FIG. 3, a flow diagram of a method 300 for allowing a customer to make donations to various third parties (organizations) based on information of a user is shown, according to an example embodiment. Various operations of the method 300 may be conducted by the computing environment 100 and particularly parts thereof (e.g., the institution computing system 110, the customer device 140, the organization system 160, the transfer service computing system 180, and/or the third party service provider 190).

At step 305, the institution computing system 110 (e.g., the transaction circuit 130) receives organization information from one or more organization systems 160. As described herein, the transaction circuit 130 may receive one or more data packets and/or or documents including the organization information during a registration process. For example, the transaction circuit 130 may receive the organization information responsive to transmitting a request for information transmitted to the organization system 160 for registering the organization of the organization system 160 with a service of the institution computing system 110 and/or the transfer service computing system 180. The request may include, for example, a predefined file format for a user of the organization to complete and transmit to the institution computing system 110. The transaction circuit 130 may extract the organization information from the predefined file format. By way of example, the transaction circuit 130 may transmit a message (e.g., email, SMS, notification, etc.) to the organization system 160. The message may include one or more manual inputs for a user to complete to provide the organization information (e.g., a selection of a category type, name, address, tokens and/or identifiers, employer identification number (EIN), a bank routing number, a bank account number, and/or other various information). The transaction circuit 130 may receive the organization information responsive to the organization system 160 transmitting the completed message back to the institution computing system 110 to complete the registration. The transaction circuit 130 may store the information in the organizations database 120.

At step 310, the transaction circuit 130 categorizes the organization based on the received organization information. For example, as described herein, the received organization information of the organization system 160 may include a selection and/or other indication of a category type of the organization (e.g., selected from a finite number of predetermined categories). The transaction circuit 130 may categorize the organization based on the received category type. In some implementations, the transaction circuit 130 may categorize the organization based one or more machine learning models, as described herein. The transaction circuit 130 may categorize the organization by, for example, storing the transaction type within the organizations database 120 with the organization information.

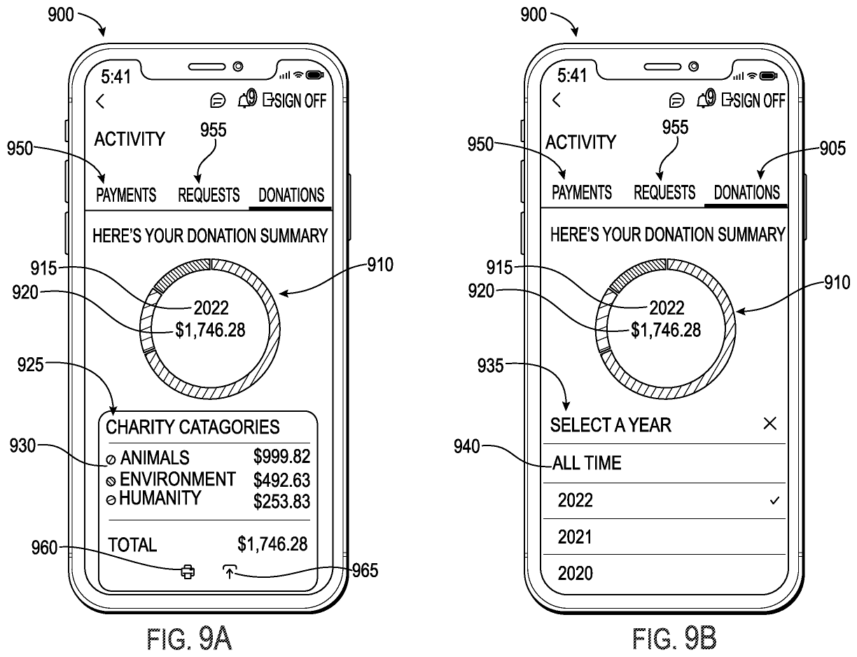

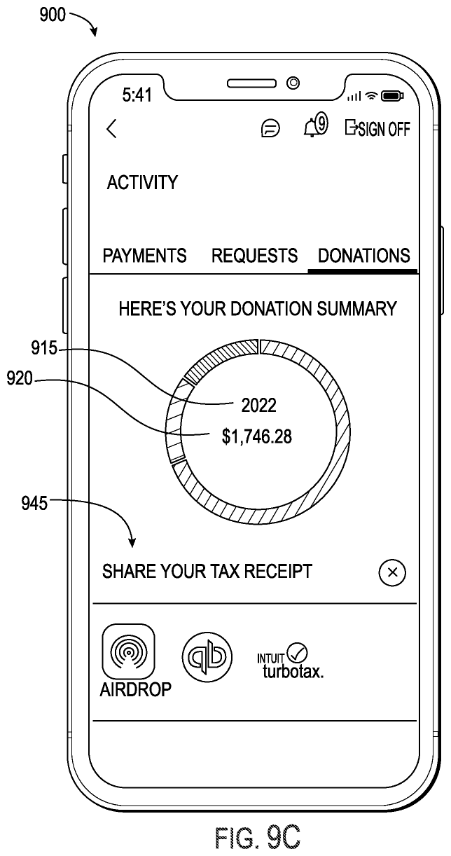

At step 315, the transaction circuit 130 receives a user input to a user interface of the customer device 140. For example, responsive to receiving a manual user input to the activity button 510 depicted in FIGS. 5A and 5B, the transaction circuit 130 may cause the network interface circuit 135 to generate and provide the six user interface 900 shown in FIGS. 9A-9C to the customer device 140. As shown in the example sixth user interfaces 900 depicted in FIGS. 9A-9C, the user interface 900 may include one or more sections that display a customer's activity (e.g., transaction and/or donation activity of an account associated with a user of the customer device 140). For example, the user interface 900 may include a payments tab 950, a requests tab 955, and/or a donations tab 905. Responsive to receiving an input to the payments tab 950, the account management circuit 125 may cause the network interface circuit 135 to generate and render a listing of previous payments that a user of the customer device 140 has sent to a recipient (e.g., by pulling transaction data stored in the accounts database 115). Responsive to receiving an input to the requests tab 955, the account management circuit 125 may cause the network interface circuit 135 to generate and render a listing of previous received payments that a user of the customer device 140 has received from a sender (e.g., by pulling transaction data stored in the accounts database 115).

Responsive to receiving an input to the donations tab 905, the transaction circuit 130 may cause the network interface circuit 135 to generate and render a graphic and/or listing of a summary of donations that a user of the customer device 140 has made (e.g., based on donation transactions described with reference to FIG. 2). For example, the donations tab 905 may include at least one graphical representation 910 of a summary of donations made by a user. The graphical representation 910 may include various images, videos, or other graphics that depict a breakdown of categories of donations that a user has donated to. For example, the graphical representation 910 may include a pie chart, bar graph, or other graphic that displays an amount of donations contributed to one category relative to another category.

The graphical representation 910 may include an indication of a time period 915 of the donations made (e.g., a specified year, day, etc.). In some implementations, the indication of the time period 915 may include a selectable feature such that the transaction circuit 130 may cause the network interface circuit 135 to generate and render a listing 935 of time periods for a user to choose from, as shown in FIG. 9B. The listing may include one or more selectable time elements 940 for a user to select. For example, responsive to receiving a manual input to a selectable time element 940, the transaction circuit 130 may cause the network interface circuit 135 to generate and render a graphical representation 910 of a summary of donations for the selected time period.

The graphical representation 910 may include an indication of a total donation amount 920 for the selected time period (e.g., a specified year, day, etc.). In some implementations, the indication of the total donation amount 920 may include a selectable feature such that the transaction circuit 130 may cause the network interface circuit 135 to generate and render a listing of previous donations associated with a customer account (e.g., for all categories). For example, the listing of previous donations may include a list of donations organized by date, time, location, and/or other selections.

The graphical representation 910 may include an indication of how the user account's donation history ranks relative one or more other accounts. For example, the transaction circuit 130 may be structured to receive and/or pull information of the transfer service computing system 180 (e.g., via an API call, during a registration process, etc.) including historical and/or average information of donations contributed to each organization. The transaction circuit 130 may compare a donation amount contributed to one or more organizations of the user account associated with the customer device 140 with the received historical information and/or average information. The transaction circuit 130 may determine a ratio or difference between the user's donated amount and the historical or average donation amount. The transaction circuit 130 may cause the network interface circuit 135 to render an indication of the ratio or difference on the user interface 900. For example, the indication may include one or more texts, images, sounds, or other features (e.g., “you are the top contributor to charity A,” “you've donated $60 less than an average amount donated to charity A,” etc.).

The donations tab 905 may include at least one category list 925 that displays one or more category keys 930 relative to the graphical representation 910. The category keys 930 may include one or more colors, symbols, or other indications that match a name of a category with a portion of the graphical representation 910 (e.g., a red key 930 corresponds to a red portion of the graphical representation so a user can easily determine how much has been donated to a specific category). In some implementations, the transaction circuit 130 may cause the network interface circuit 135 to update and/or move the positions of the category keys 930 based on an amount of donations contributed to the corresponding category. For example, the transaction circuit 130 may determine the total donation amount 920 contributed to organizations from a user account over a predetermined time period (e.g., a year). The transaction circuit 130 may determine a ratio of an amount donated to one or more categories relative to the total donation amount 920. The transaction circuit 130 may rank the ratios of one or more categories in order from largest ratio (e.g., largest amount donated in comparison to the total amount) to smallest. The transaction circuit 130 may cause the network interface circuit 135 to automatically relocate the category keys 930 based on the amount of donations contributed to the corresponding category such that a user of the customer device 140 can readily find the category most donated to.

Automatically moving the graphical representations of the category keys 930 of the user interface may provide many advantages over conventional techniques. For example, typical computer systems are limited in ways to organize displayed information on a user interface. By automatically moving graphical representations of a user interface based on a total amount of donations, the systems and methods described herein provide a specific and particular manner of automatically displaying features to a user based on relevance of the feature in relation to a user's spending habits.

The one or more category keys 930 can include at least one selectable feature. For example, responsive to a manual input to a category key 930, the transaction circuit 130 may cause the network interface circuit 135 to generate and render a listing of donations contributed to organizations associated with the selected category. For example, a user may select a category key 930 corresponding to, for example, the “animals” category. Responsive to receiving the selection, the transaction circuit 130 may cause the network interface circuit 135 to generate and render a listing of all donations of the predetermined time period made to organizations categorized under “animals” by pulling transaction data from the accounts database 115.

Referring back to FIG. 3, at step 320, the transaction circuit 130 determines at least one parameter (e.g., category) of an organization matches a selection of the category key 930. For example, the transaction circuit 130 may recommend making a donation to a category based on the user input to the category key 930 by matching organizations that have not yet been donated to with the selected category. In some implementations, the transaction circuit 130 may transmit a notification indicating to donate to a charity matching the selected category responsive to receiving an input to the category key 930. For example, the notification may include a pop-up notification including text, images, sounds, vibrations, or other features to facilitate getting the attention of a user (e.g., “you donated over $900 to animals, here is another animal charity to consider,” “you previously donated to charity A, here is another charity that helps connect animals to forever homes,” etc.).

In some implementations, the transaction circuit 130 may transmit a notification including a recommended organization with or without receiving a selection of a category key 930. For example, the transaction circuit 130 may recommend an organization responsive to analyzing transaction history of the account associated with the customer device 140. The transaction circuit 130 may determine, based on the transaction history stored in the accounts database 115, that a user of the account has had one or more transactions associated with a specific category. For example, the transaction circuit 130 may be structured to extract various information associated with a user's transaction history (e.g., spending habits including names of merchants, amount spent, items purchased, etc.) stored in the accounts database 115. By way of example, the transaction circuit 130 may determine a user has made multiple transactions at a pet store within a predetermined period of time (e.g., a month, a year, etc.). The transaction circuit 130 may parse the organizations database 120 for keywords associated with each predetermined category of organizations and determine, based on the parse information, that a pet store is associated with the “animal” organization category. The transaction circuit 130 may transmit a notification to the customer device 140 recommending an organization of the animal category for a user to make a donation.

In some implementations, the transaction circuit 130 may transmit a notification including a recommended organization responsive to analyzing information of the user and/or user account associated with the customer device 140. For example, as described herein, the transaction circuit 130 may receive various user information of the user associated with the customer device 140 during a registration and/or log-in process with the institution computing system 110 (e.g., information received by the account management circuit 125 and stored in the accounts database 115 responsive to a user logging into and/or creating an account at the financial institution). The information of the user may include, for example, an age of the user, known preferences of the user (e.g., cash back selections), an address of the user, and/or various other information). In some implementations, the transaction circuit 130 may receive various user information in real-time or near real-time. For example, the transaction circuit 130 may receive real-time location information of a user from one or more geolocation sensors of the customer device 140. The transaction circuit 130 may determine that the location is within a predetermined distance threshold of an address of an organization responsive to comparing the location with a plurality of address data stored in the organizations database 120. The transaction circuit 130 may transmit a notification including a recommendation to donate to the organization nearby the user's location responsive to determining the user is near the organization.

At step 325, the transaction circuit 130 causes the network interface circuit 135 to generate and render at least a portion of a graphical representation 705 of a recommended organization on the user interface (e.g., as shown in the fourth user interface 700 and/or fifth user interface 800). For example, the transaction circuit 130 may cause the network interface circuit 135 to generate and render the graphical representation 705 responsive to receiving a manual user input to the notification including the recommended organization indicating the user wishes to view information of the organization. As described herein, the graphical representation 705 may not include a personalized token associated with the organization.

At step 330, the transaction circuit 130 receives an input to a user interface indicating a selection to donate to the recommended organization. For example, in some implementations, the transaction circuit 130 may receive a manual user input to the donate button 735 of the user interface 700 depicted in FIG. 7, indicating a user wishes to donate to the organization. In some implementations, the transaction circuit 130 may receive one or more user inputs to the user interface 800 displayed in FIGS. 8A-8E for a user to complete a donation, as described herein.

At step 335, the transaction circuit 130 causes an initiation of funds between an account of the user associated with the customer device 140 and an account of the organization (e.g., stored in the organizations database 120), as described with reference to FIG. 2.

In some implementations, the transaction circuit 130 may receive a manual input to the sixth user interface 900 indicating a selection to generate, render, and/or transmit a report indicating a confirmation of a donation and/or a summary of donations report of the user account within a predetermined time period. For example, the confirmation and/or summary report may include a date, amount, and/or other information of one or more donations to share with various users and/or submit to one or more tax forms or sites (e.g., TurboTax®, QuickBooks®, Intuit®, etc.). In some implementations, the transaction circuit 130 may generate and transmit a confirmation and/or summary report to a printing device connected to the network 170 responsive to receiving an input to a print button 960. In some implementations, the transaction circuit 130 may cause the network interface circuit 135 to generate and render a share feature 945 on the user interface 900 responsive to receiving an input indicating a user wishes to share a confirmation and/or summary report with another user or entity (e.g., responsive to selecting a share button 965), as depicted in FIGS. 9A and 9C. The share feature 945 may include various options to share the confirmation or summary report including, but not limited to, sharing with a contact stored in the customer device 140, sharing on a social media platform, sharing with a tax or accounting services, or other entities/users. In some implementations, the transaction circuit 130 may transmit the generated confirmation or summary of donations report to a contact stored in the customer device 140 or via a social media application by establishing a real-time API link between the institution computing system 110 and an application of the customer device 140 (e.g., a contact application, a messaging application, a social media application, a tax return application, etc.). For example, the transaction circuit 130 may cause a server of the institution computing system 110 to transmit an API call to a server of the applications to form an API communication link between the institution computing system 110 and the application to transmit the confirmation or summary of donations report in real-time.

In some implementations, the transaction circuit 130 may cause the institution computing system 110 to transmit a confirmation and/or summary of donations report directly to, for example, a third party service provider 190 in which the third party service provider 190 includes one or more tax and/or accounting providers (e.g., TurboTax®, QuickBooks®, Intuit®, TransUnion, Equifax, Experian, etc.) responsive to receiving an input to the share feature 945. In some implementations, the transaction circuit 130 may transmit the generated confirmation or summary of donations report to a third party service provider 190 by establishing a real-time API link between the institution computing system 110 and the third party service provider 190. In some implementations, the transaction circuit 130 may cause the network interface circuit 135 to transmit the generated confirmation or summary of donations report to the third party service provider 190 via the network 170. The confirmation or summary report may include an indication of an account used to make the donation (e.g., personal or business as described with reference to FIGS. 8B-8C.

In some implementations, the transaction circuit 130 may receive a user input to the user interface 900 indicating a request to define one or more goals for the user associated with the customer device 140 for making donations. For example, the transaction circuit 130 may receive an input corresponding to a specific amount goal for an organization and/or for a specific category of organizations for a user to meet over a predetermined period of time (e.g., goal to donate $1000 to animal charities over a year to meet a tax write-off goal). The transaction circuit 130 may be structured to compare transaction activity of the user account of the customer device 140 with the defined goal to dynamically update a status of the goal (e.g., a percentage or amount completed or remaining). The transaction circuit 130 may cause the network interface circuit 135 to generate and render an indication of a status of the goal to the user interface 900 responsive to the comparison. In some implementations, the transaction circuit 130 may generate and transmit a notification to the customer device 140 responsive to determining a donation was made and/or responsive to a status update of the goal. For example, the transaction circuit 130 may transmit a notification to the customer device 140 indicating a percentage or amount remaining to reach a defined goal responsive to receiving transaction activity. As another example, the transaction circuit 130 may transmit a notification to the customer device 140 indicating a user has met a goal responsive to receiving transaction activity. In some implementations, the transaction circuit 130 may receive a user input to the user interface 900 indicating to set up recurring transactions to an organization to facilitate meeting the goal. For example, the transaction circuit 130 may receive an input indicating the user wishes to donate a certain amount one or more times over a predetermined time period. The transaction circuit 130 may automatically cause an initiation of funds responsive to receiving the input at the selected time intervals.

In some implementations, the transaction circuit 130 may receive a user input to one or more user interfaces described herein indicating a request to invite other users to donate to a selected organization. For example, the transaction circuit 130 may be structured to establish an API link with one or more applications of the customer device 140 responsive to receiving an input to the customer device 140 (e.g., to an invite users to donate button). The transaction circuit 130 may generate one or more uniform resource locator (URL) links, one or more encrypted codes (e.g., bar codes, QR codes, etc.), and/or various other locaters associated with a selected organization for transmitting to another user through the API link responsive to receiving the input. For example, the transaction circuit 130 may cause the institution computing system 110 to transmit the generated URL and/or code to another user device for a user to scan the code and/or click on the URL link to donate to an organization.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system of a provider institution, comprising:
a network interface configured to communicate with a user device and a plurality of third party systems;
a database configured to store information regarding a plurality of accounts of the provider institution; and
a processing circuit comprising at least one processor and at least one memory, the at least one memory structured to store instructions that are executable to cause the at least one processor to:
receive, via the network interface, first third party information from a first third party system of the plurality of third party systems, the first third party information including a first third party account and a selection of a first category type of the first third party system;
receive, via the network interface, second third party information from a second third party system of the plurality of third party systems, the second third party information including a selection of a second category type of the second third party system;
generate a graphical user interface (GUI), the GUI comprising a first graphical representation of the first category type and a second graphical representation of the second category type;
provide, via the network interface, the GUI to the user device;
receive, via the network interface, a first user input to the GUI indicating a selection to transfer a resource from an account of the plurality of accounts to the first third party account of the first third party system;
update, responsive to receiving the selection to transfer the resource, a total amount of resources associated with the first category type;
compare the total amount of resources associated with the first category type with historical transaction data of the account stored in the database;
determine, based on the comparison, that the total amount of resources associated with the first category type exceeds a total amount of resources associated with the second category type; and
automatically update, via the network interface, a position of the first graphical representation of the first category type relative to the second graphical representation of the second category type on the GUI responsive to determining that the total amount of resources associated with the first category type exceeds the total amount associated with the second category type.

2. The computing system of claim 1, wherein the first third party information includes a first personalized token of the first third party account of the first third party system and the instructions further cause the at least one processor to render, via the network interface, a graphical representation of the first third party system on the GUI, wherein the graphical representation does not include the first personalized token.

3. The computing system of claim 1, wherein the second third party information includes an address of the second third party system and the instructions further cause the at least one processor to:
receive, via the network interface and via a position sensor of the user device, a location of the user device;
determine, based on the address of the second third party system, that the location is within a predetermined distance of the address; and
transmit, via the network interface, a notification to the user device including a recommendation to transfer additional resources to the second third party system.

4. The computing system of claim 1, wherein the instructions further cause the processor to:
receive, via the network interface, a second user input to the GUI, the second user input indicating a selection to share information of the transfer of resources with an entity system;
generate a report including the information of the transfer of funds; and
transmit, via a third party application programming interface (API), the report to the entity system.

5. The computing system of claim 1, wherein the instructions further cause the processor to:
receive, via the network interface, a second user input to the GUI, the second user input indicating a selection of a predetermined time period;
generate a report including transaction history of the predetermined time period of the account of the plurality of accounts; and
provide, via the network interface, the report to the user device.

6. The computing system of claim 1, wherein the instructions further cause the processor to:
render, via the network interface, a graphical representation of a summary of transactions of the account of the plurality of accounts over a predetermined period of time; and
wherein the graphical representation of the summary of transactions of the account includes a first section indicating the total amount associated with the first category type and a second section indicating the total amount associated with the second category type.

7. The computing system of claim 1, wherein the instructions further cause the processor to:
parse account information of the account stored in the database;
determine, based on the account information, that at least one data element of the account information matches at least one data element of the second third party information of the second third party system; and
transmit, via the network interface, a notification to the user device including a recommendation to transfer funds to the second third party system.

8. The computing system of claim 1, wherein the first third party system comprises at least one of a charity or a non-profit organization.

9. A computing system of a provider institution, comprising:
a network interface configured to communicate with a user device and a third party system;
a database configured to store information regarding the third party system; and
a processing circuit comprising at least one processor and at least one memory, the at least one memory structured to store instructions that are executable to cause the at least one processor to:
receive, via the network interface, third party information from the third party system, the third party information including a personalized identifier of a third party account of the third party system;
store the third party information in the database;
generate a graphical user interface (GUI), the GUI comprising a selectable graphical representation of a third party associated with the third party system, wherein the selectable graphical representation does not include the personalized identifier associated with the third party account;
provide, via the network interface, the GUI to the user device;
receive, via the network interface, a first user input to the GUI indicating a selection to transfer a resource to the third party; and
cause a transfer of the resource from an account associated with the user device to the third party account associated with the third party system responsive to receiving the first user input.

10. The computing system of claim 9, wherein the third party information includes a category type of the third party system and the instructions further cause the at least one processor to:
render, via the network interface, a graphical representation of a plurality of selectable category types on the GUI, the plurality of selectable category types including the category type of the third party system;
receive, via the network interface, a second user input to the GUI indicating a selection of the category type of the third party system; and
render, via the network interface, the selectable graphical representation of the third party associated with the third party system responsive to receiving the second user input to the GUI.

11. The computing system of claim 9, wherein the third party information includes a category type of the third party system and the instructions further cause the at least one processor to:
render, via the network interface, a selectable feature associated with a dialogue box on the GUI;
receive, via the network interface, a second user input to the GUI an input to the selectable feature associated with the dialogue box;
parse the database based on the second user input;
determine that the input to the selectable feature matches at least one data element associated with the third party information of the third party system; and
render, via the network interface, the selectable graphical representation of the third party associated with the third party system responsive to receiving the second user input to the GUI.

12. The computing system of claim 9, wherein the third party information comprises first third party information and the instructions further cause the at least one processor to:
receive, via the network interface, second third party information of a second third party system communicably coupled to the computing system;
compare the second third party information with the first third party information;
determine, based on the comparison, that at least one data element of the second third party information matches a data element of the first third party information; and
transmit, via the network interface, a notification to the user device responsive to determining that the at least one data element of the second third party information matches the data element of the first third party information, the notification including a recommendation to transfer resources to the second third party system.

13. The computing system of claim 9, wherein the third party information includes a name of the third party and the instructions further cause the at least one processor to transmit the name of the third party to a transfer service computing system communicably coupled to the computing system to cause the transfer of the resource from the account associated with the user device to the third party account associated with the third party system.

14. The computing system of claim 9, wherein the third party system comprises at least one of a charity or a non-profit organization.

15. A computer-implemented method, comprising:
receiving, by a computing system, third party information from a third party system communicably coupled to the computing system via a network interface, the third party information including a personalized identifier of a third party account of the third party system;
storing, by the computing system, the third party information in a database of the computing system;
generating, by the computing system, a graphical user interface (GUI), the GUI comprising a selectable graphical representation of a third party associated with the third party system, wherein the selectable graphical representation does not include the personalized identifier associated with the third party;
providing, by the computing system and via the network interface, the GUI to a user device communicably coupled to the computing system;
receiving, by the computing system and via the network interface, a first user input to the GUI indicating a selection to transfer a resource to the third party; and
causing, by the computing system, a transfer of the resource from an account associated with the user device to the third party account associated with the third party system.

16. The method of claim 15, wherein the third party information includes a category type of the third party system and the method further comprises:
rendering, by the computing system and via the network interface, a graphical representation of a plurality of selectable category types on the GUI, the plurality of selectable category types including the category type of the third party system;
receiving, by the computing system and via the network interface, a second user input to the GUI, the second user input indicating a selection of the category type of the third party system; and
rendering, by the computing system and via the network interface, the selectable graphical representation of the third party associated with the third party system responsive to receiving the second user input to the GUI.

17. The method of claim 15, wherein the third party information includes a category type of the third party system and the method further comprises:
rendering, by the computing system and via the network interface, a selectable feature associated with a dialogue box on the GUI;
receiving, by the computing system and via the network interface, a second user input to the GUI, the second user input indicating an input to the selectable feature associated with the dialogue box;
parsing, by the computing system, the database based on the second user input;
determining, by the computing system, that the input to the selectable feature matches at least one data element associated with the third party information of the third party system; and
rendering, by the computing system and via the network interface, the selectable graphical representation of the third party associated with the third party system responsive to receiving the second user input to the GUI.

18. The method of claim 15, wherein the third party information comprises first third party information and the method further comprises:
receiving, by the computing system and via the network interface, second third party information of a second third party system communicably coupled to the computing system;
comparing, by the computing system, the second third party information with the first third party information;
determining, by the computing system, based on the comparison, that at least one data element of the second third party information matches a data element of the first third party information; and
transmitting, by the computing system and via the network interface, a notification to the user device responsive to determining that the at least one data element of the second third party information matches the data element of the first third party information, the notification including a recommendation to transfer resources to the second third party system.

19. The method of claim 15, wherein the third party information includes a name of the third party and the method further comprises transmitting the name of the third party to a transfer service computing system communicably coupled to the computing system via the network interface to cause the transfer of the resource from the account associated with the user device to the third party account associated with the third party system.

20. The method of claim 15, wherein the third party system comprises at least one of a charity or a non-profit organization.
